(19) United States
(12) Patent Application Publication
(10) Pub. No.: US 2018/0088785 A1
(43) Pub. Date: Mar. 29, 2018

(54) NAVIGATING A SET OF SELECTABLE ITEMS IN A USER INTERFACE

(71) Applicant: Flow Labs, Inc., Menlo Park, CA (US)

(72) Inventors: Leon VAN NIEKERK, Stellenbosch (ZA); Francois VAN NIEKERK, Somerset West (ZA); Hilgard Heyns BELL, Stellenbosch (ZA); Willem Morkel VAN DER WESTHUIZEN, Stellenbosch (ZA)

(21) Appl. No.: 15/553,156

(22) PCT Filed: Feb. 26, 2016
(86) PCT No.: PCT/IB16/51047

§ 371 Date: Aug. 23, 2017

(30) Foreign Application Priority Data
Feb. 26, 2015 (ZA) 2015/01306

(51) Int. Cl. G06F 3/0484; G06F 3/0482; G06F 3/0481; G06F 3/0485

(52) U.S. Cl. CPC G06F 3/04845; G06F 3/0485; G06F 3/04817; G06F 3/0482

(57) ABSTRACT

A method of navigation of a set of selectable items in a user interface of an electronic device is provided. A set of selectable items are retrieved and divided into a plurality of successive rows. Only a subset of the rows are displayed on a display of the electronic device. User input is tracked, and may be in the form of scrolling or zooming. Scrolling through the display and/or zooming in or out of the display is then applied as appropriate. Selectable items are rearranged on the rows as zooming is performed, while scrolling causes the subset of visible rows to update.

### CROSS-REFERENCE TO RELATED APPLICATION

This application claims priority from South African provisional patent application number 2015/01306 filed on 26 Feb. 2015, which is incorporated by reference herein.

### FIELD OF THE INVENTION

This invention relates to navigation of selectable items in a user interface. More particularly, the invention relates to a method and user interface enabling a user to navigate a set of selectable items displayed by an electronic device.

### BACKGROUND TO THE INVENTION

In many electronic devices, such as mobile phones, tablet computers, personal computers, televisions, and the like, a user interface is provided which receives user input and controls and adjusts a display of the electronic device so as to allow a user to interact with the electronic device.

Typically, a plurality of selectable items are available to the user and the user may be required to operate a pointer to select one of the selectable items. The pointer used to select selectable items may be the position, movement and/or touch of a finger or fingers of the user, or of any other suitable direct or indirect pointing tool. The set of selectable items may, for example, be icons, menu items, applications, an images or videos, buttons or any other items which may be or become positioned in a display region of the electronic device.

A number of methods have been developed to allow a user to select one of a set of selectable items displayed on a touch-sensitive display. Typically, the user is required to perform actions such as swiping or pinching in order to reach a desired selectable item, and then perform a selection action to select the selectable item. For example, a large number of photos, videos or menu icons may be available for selection and a pointing finger may be used to navigate to and select a desired item by touching it.

A problem associated with certain user interface implementations is that it may be difficult or cumbersome for a user to reach a desired item from a large set without providing a number of discrete inputs so as to make the desired item visible and/or sufficiently clear on the display of the electronic device. As a result, a number of so-called “point and click” actions may be required before the desired item is brought into view. Furthermore, existing user interfaces may not provide the user with an overarching view of items available for selection so as to facilitate reaching the desired item more rapidly.

The present invention aims to address these and other problems, at least to some extent.

Throughout this specification, the term “selectable item” or “item” should be broadly interpreted and is used to refer to any target provided by a user interface which may or may not be displayed at that time and which a user may wish to select, view, modify, or the like.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with the invention there is provided a method of navigation of a set of selectable items in a user interface associated with an electronic device, the method comprising the steps of:
retrieving a set of selectable items;
dividing the set of items into a plurality of successive rows;
displaying a subset of the rows on a display of the electronic device;
tracking scrolling user input activating scrolling through the display;
tracking zooming user input activating zooming in or out of the display;
in response to detecting scrolling user input, causing scrolling to be performed in relation to the set of items to enable the user to view rows not previously in the displayed subset without substantially adjusting the size and number of items per row;
in response to detecting zooming user input in a zooming-out direction, proportionally to user input detected, progressively causing items to decrease in size and concurrently flow along the rows in an order towards an anchor point so as to dynamically rearrange each row such that the number of items per row progressively increases and at least some items not previously in the displayed subset flow into the display; and
in response to detecting zooming user input in a zooming-in direction, proportionally to user input detected, progressively causing items to increase in size and concurrently flow along the rows in an order away from the anchor point, so as to dynamically rearrange each row such that the number of items per row progressively decreases and at least some items recede from the display.

Further features provide for the step of tracking scrolling user input to include tracking user input in the form of pointer movement along a scrolling axis; and for the step of tracking zooming input to include tracking user input in the form of pointer movement along a substantially transverse zooming axis.

Further features provide for individual items in each row to be positioned according to a defined order such that the last item in row Y is an item X and the first item in row Y+1 is item X+1; for at least one last item in a row to be cut off so as to be displayed partially at the end of the row and partially at the beginning of a succeeding row thereby providing a technical effect of informing a user that there are more items to come on the next row; and for the rows to extend substantially transversely to the scrolling axis.

Still further features provide for the step of causing items to decrease in size and concurrently flow along the rows in the defined order towards the anchor point to include items in rows preceding the anchor point flowing towards the anchor point in a first direction and items in rows succeeding the anchor point flowing towards the anchor point in a second direction; and for the step of causing items to increase in size and concurrently flow along the rows in the defined order away from the anchor point to include items in rows preceding the anchor point flowing away from the anchor point in the second direction and items in rows succeeding the anchor point flowing away from the anchor point in the first direction.

The anchor point may be associated with a predefined position on the display of the electronic device, a predefined item position and/or a predefined row position, or may be dynamically positioned by user input

In some embodiments, the method may include the steps of, upon detecting both scrolling user input and zooming user input, causing scrolling and zooming-in or zooming-out to be substantially simultaneously performed.

Yet further features provide for the method to include displaying markers along with the subset of rows on the display of the electronic device, the markers identifying common features of groups of items in the set; for the markers to be arranged along the scrolling axis; or, alternatively, for the markers to be arranged between some of the items in the rows. In some embodiments, scrolling and dynamic rearrangement of rows causes dynamic rearrangement of markers. The defined order may be determined based at least partially on the markers.

Further features provide for the rows of selectable items to form a first z-axis layer; for the markers to be provided in a second and/or subsequent z-axis layers that are partially visible so as to be arranged between some of the items in the rows; and for scrolling or dynamic rearrangement of rows to cause different portions of the second and/or subsequent layers to become visible.

In some embodiments, the selectable items may be images or videos, and the markers may be timeline markers identifying certain periods of time associated with the images or videos.

Yet further features provide for the scrolling axis to be defined as a longitudinal axis associated with the display; for the zooming axis to be defined as a short axis associated with the display; and for the user interface to be configured to provide a zooming direction reversal option such that the zooming-direction becomes the zooming-out direction and the zooming-out direction becomes the zooming-in direction. Alternatively, the scrolling axis may be a short axis, and the zooming axis may be the longitudinal axis.

The invention extends to a user interface configured to enable navigation of a set of selectable items wherein the user interface is interface associated with an electronic device, the user interface comprising:
an item retrieving component configured to retrieve a set of selectable items;
a row allocation component configured to divide the set of items into a plurality of successive rows;
a display component configured to display a subset of the rows on a display of the electronic device;
a scrolling tracking component configured to track scrolling user input;
a zooming tracking component configured to track zooming user input in or out of the display;
a scrolling component configured to, in response to detecting user input, cause scrolling to be performed in relation to the set of items to enable the user to view rows not previously in the displayed subset without substantially adjusting the size and number of items per row; and
a zooming component configured to:
   in response to detecting user input in a zooming-out direction, proportionally to user input detected, progressively cause items to decrease in size and concurrently flow along the rows in an order towards an anchor point so as to dynamically rearrange each row such that the number of items per row progressively increases and at least some items not previously in the displayed subset flow into the display; and
   in response to detecting zooming user input in a zooming-in, proportionally to user input detected, progressively cause items to increase in size and concurrently flow along the rows in an order away from the anchor point, so as to dynamically rearrange each row such that the number of items per row progressively decreases and at least some items recede from the display.

Further features provide for the zooming component to be configured to, while causing items to decrease in size and concurrently flow along the rows in the order towards the anchor point, cause items in rows preceding the anchor point to flow towards the anchor point in a first direction and items in rows succeeding the anchor point to flow towards the anchor point in a second direction; and to be configured to, while causing items to increase in size and concurrently flow along the rows in the order away from the anchor point, cause items in rows preceding the anchor point to flow away from the anchor point in the second direction and items in rows succeeding the anchor point to flow away from the anchor point in the first direction.

Still further features provide for the user interface to be configured to, upon detecting both scrolling user input and zooming user input, cause scrolling and zooming-in or zooming-out to be substantially simultaneously performed

The user interface may further include a marker component configured to display markers along with the subset of rows on the display of the electronic device, the markers identifying common features of groups of items in the set.

The invention extends to a computer program product for navigation of a set of selectable items in a user interface associated with an electronic device, the computer program product comprising a non-transitory computer-readable medium having stored computer-readable program code, the computer-readable program code executable by a processing circuit to perform the steps of:
retrieving a set of selectable items;
dividing the set of items into a plurality of successive rows;
displaying a subset of the rows on a display of the electronic device;
tracking scrolling user input activating scrolling through the display;
tracking zooming user input activating zooming in or out of the display;
in response to detecting scrolling user input, causing scrolling to be performed in relation to the set of items to enable the user to view rows not previously in the displayed subset without substantially adjusting the size and number of items per row;
in response to detecting zooming user input in a zooming-out direction, proportionally to user input detected, progressively causing items to decrease in size and concurrently flow along the rows in the order towards an anchor point so as to dynamically rearrange each row such that the number of items per row progressively increases and at least some items not previously in the displayed subset flow into the display; and
in response to detecting zooming user input in a zooming-in direction, proportionally to user input detected, progressively causing items to increase in size and concurrently flow along the rows in the order away from the anchor point, so as to dynamically rearrange each row such that the number of items per row progressively decreases and at least some items recede from the display.

Embodiments of the invention will now be described, by way of example only, with reference to the accompanying drawings.

### BRIEF DESCRIPTION OF THE DRAWINGS

In the drawings:

FIG. 1 is a block diagram illustrating logical components of an embodiment of a user interface;

FIG. 2 is a series of conceptual drawings illustrating principles underlying embodiments of the described user interfaces;

FIG. 3 is a flow diagram illustrating a method of enabling a user to navigate a set of selectable items in a user interface associated with an electronic device;

FIGS. 4A-4H are exemplary screenshots of the display of an electronic device, illustrating different stages in a method of enabling a user to navigate a set of selectable items in a user interface of the electronic device;

FIG. 5 is a conceptual drawing illustrating principles underlying z-axis layers which may be provided by embodiments of a user interface; and

FIGS. 6A-6C are exemplary screenshots of the display of an electronic device, illustrating different stages in a method of enabling a user to navigate a set of selectable items in a user interface of the electronic device, wherein the user interface provides multiple z-axis layers.

FIG. 7 illustrates an example of an electronic device in which various aspects of the disclosure may be implemented; and,

FIG. 8 shows a block diagram of an electronic device that may be used in embodiments of the disclosure.

### DETAILED DESCRIPTION WITH REFERENCE TO THE DRAWINGS

Embodiments described herein provide a method and user interface for enabling a user to navigate a set of selectable items shown on a display associated with an electronic device. Displayed items may be divided into a number of rows which are dynamically adjusted and rearranged in accordance with the intention of a user derived from the user's input to the electronic device. Zooming user input may cause zooming out or zooming in. Zooming out may cause items to decrease in size and concurrently flow along the rows in an order towards an anchor point so as to dynamically rearrange each row such that the number of items per row progressively increases and at least some items not previously displayed flow into the display. The anchor point may be a stationary point in the user interface which is defined prior to use thereof, for example a central point on the user interface. Alternatively, the anchor point may be dynamically updated based on pointer movement on the display. The anchor point may be allocated to a position where a pointer is initially placed on a display, and may also move as scrolling takes place, typically in a direction of scrolling, to provide a more dynamic appearance to the user interface. This may also allow for easier tracking of selectable items when the items have moved through the anchor point, allowing a user to more easily track items that have been scrolled. A current anchor point location may also be remembered for at least a short period of time, to allow a user to perform clutching. The anchor point may reset if the user interface has not been interacted with for a certain period of time.

Zooming in may cause items to increase in size and concurrently flow along the rows in the order away from the anchor point, so as to dynamically rearrange each row such that the number of items per row progressively decreases and at least some items recede from the display. The anchor point may be a fixed or moveable point on the display around which selectable items appear to move during zooming in or zooming out. Zooming user input may be as a result of any suitable input provided to the electronic device, and may include single or multiple pointer movement, the turning of a knob, the pressing of a button, a gesture detectable by the electronic device, or the like.

Embodiments of the methods and user interfaces disclosed herein may provide a number of advantages over known methods and user interfaces. For example, a user may be capable of obtaining an overarching view of selectable items without being required to provide a number of separate, discrete inputs, and selectable items may be easier to locate and/or view. Moreover, implementations of such a user interface may enable a user to reach a desired item more rapidly, and in some cases reach and interact with a desired item from a relatively large number of items in a continuous pointer motion without a plurality of “point and click” actions. These and other aspects will become more apparent from the examples described below.

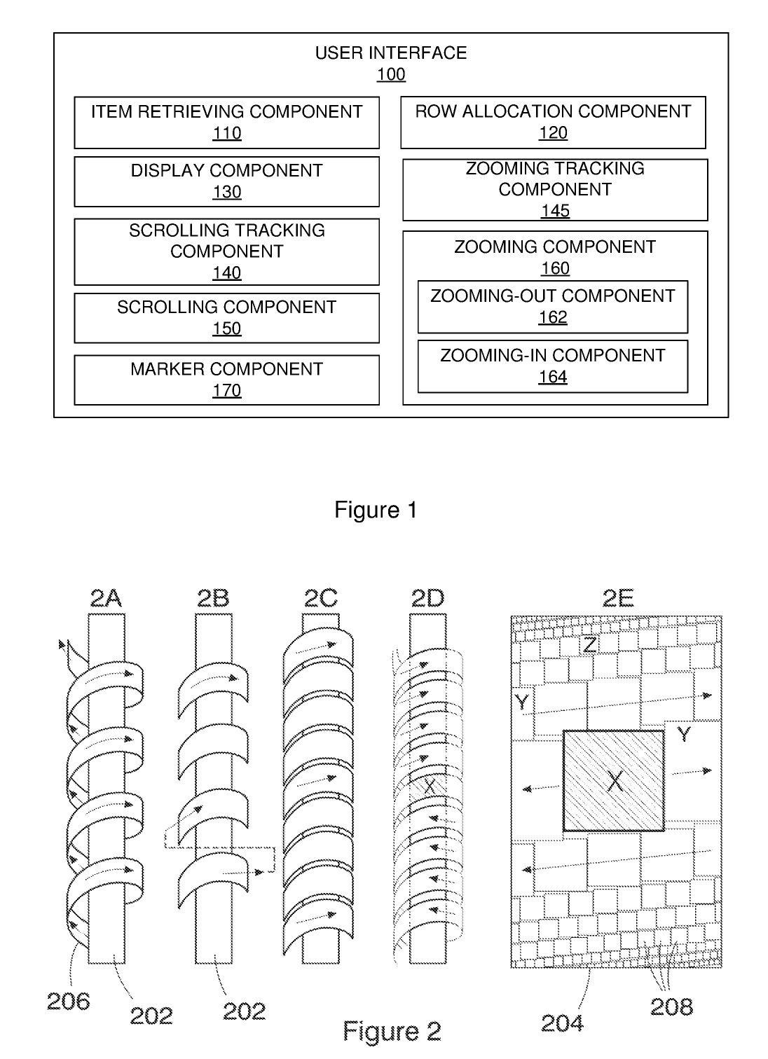

Logical components of an embodiment of a user interface (100) are illustrated in FIG. 1. The user interface (100) may be associated with a processor for executing the functions of components described below, which may be provided by hardware or by software units executing on the processor. The software units may be stored in a memory component and instructions may be provided to the processor to carry out the functionality of the described components.

The user interface (100) may include an item retrieving component (110), a row allocation component (120), a display component (130), a scrolling tracking component (140), a zooming tracking component (145), a scrolling component (150), a zooming component (160) and a marker component (170). The user interface (100) may be that of any suitable electronic device. Examples of user interfaces include, but are not limited to, those provided by the following electronic devices: mobile phones, tablet computers, personal computers, laptops, televisions and domestic appliances. Further examples include interfaces for controlling home automation systems and systems installed in automobiles. The user interface may be configured to accept direct input via a touch-screen and/or indirect input via a mouse, keyboard, or the like.

The item retrieving component (110) may be configured to retrieve a set of selectable items arranged in an order. For example, the selectable items may be an ordered set of media files such as image or video files, or an ordered set of selectable applications. Items may be arranged according to a default setting, such as according to name, date or an associated location, or may have been manually arranged by a user of the electronic device. The selectable items may be stored on a memory of the electronic device, may be accessed via the Internet, or may be obtained in any other suitable manner, as will be well understood by those of ordinary skill in the art.

The row allocation component (120) may be configured to divide the set of items into a plurality of successive rows. The items constituting each row and the properties of each row are dynamic in that, as zooming-in and zooming-out occurs, items may be gradually resized and may flow between rows. Some items may at times be displayed as “cut off” so as to be displayed partially at the end of one row and partially at the beginning of a succeeding row. These aspects will be described in greater detail with reference to a number of examples below.

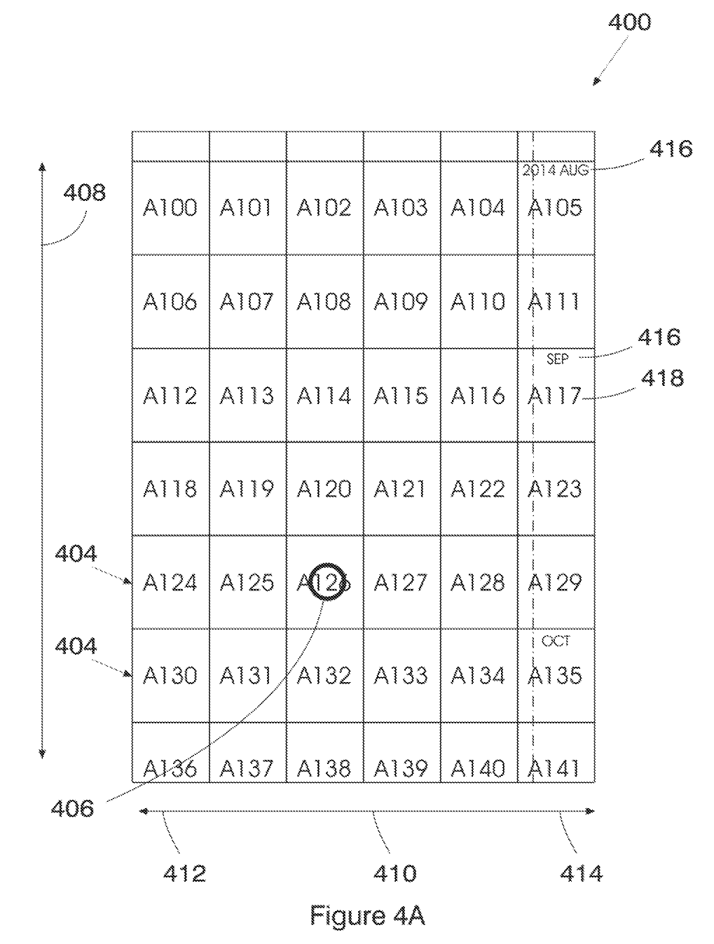

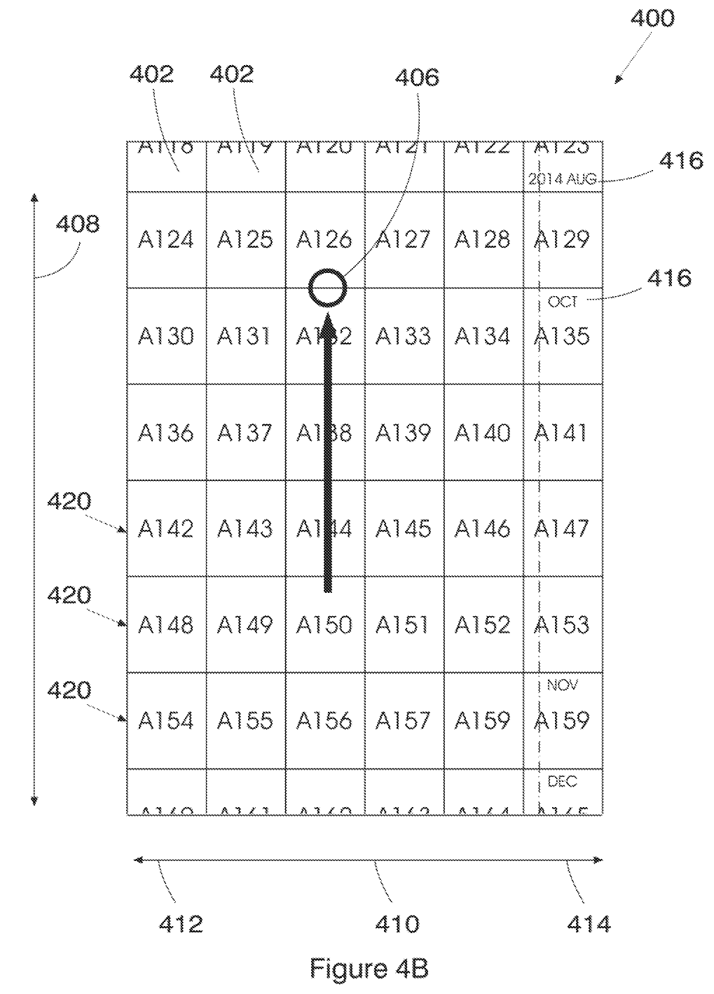

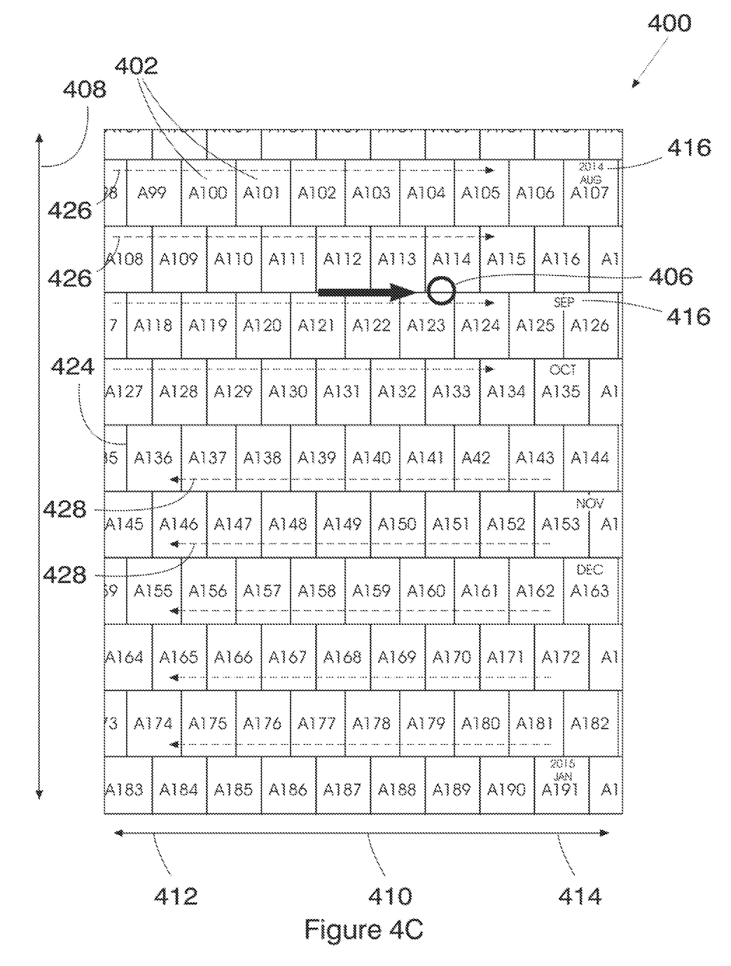

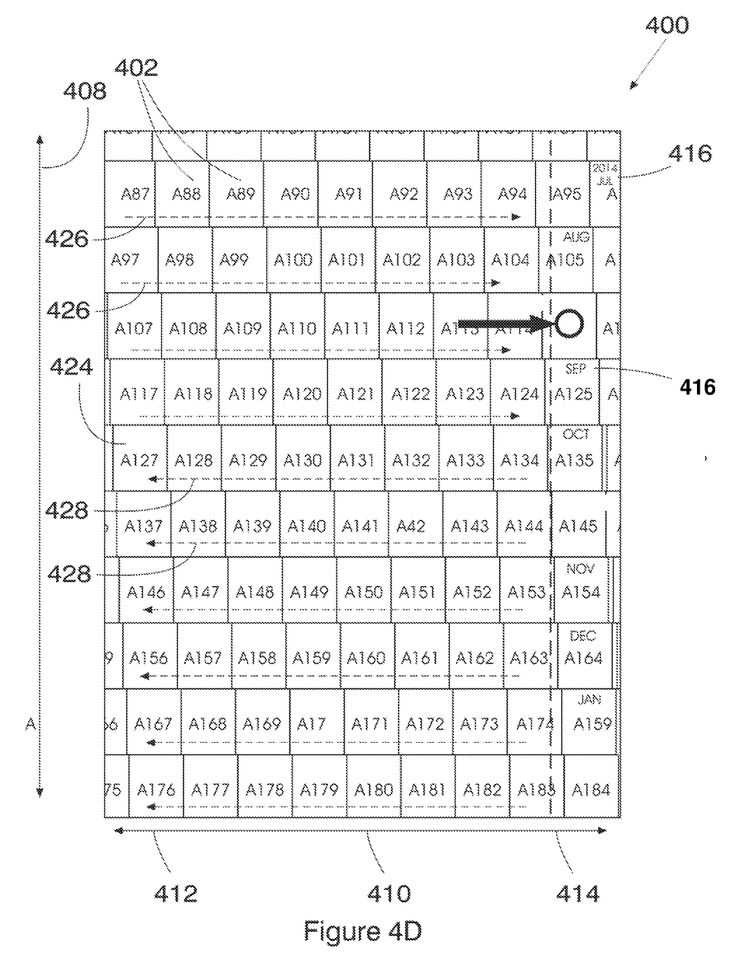

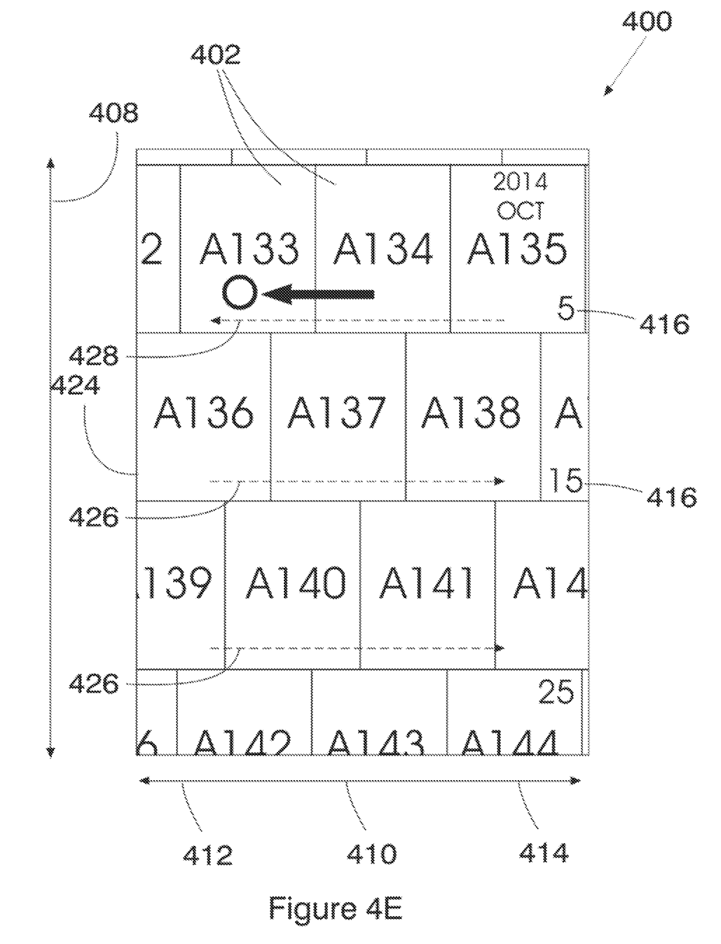

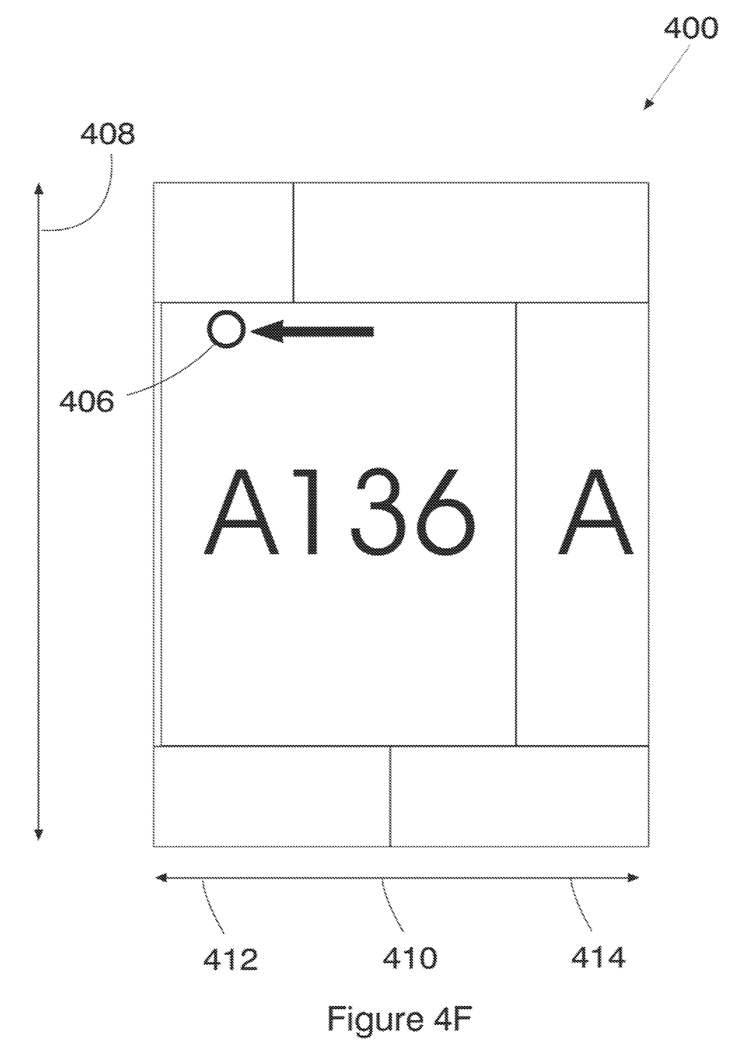

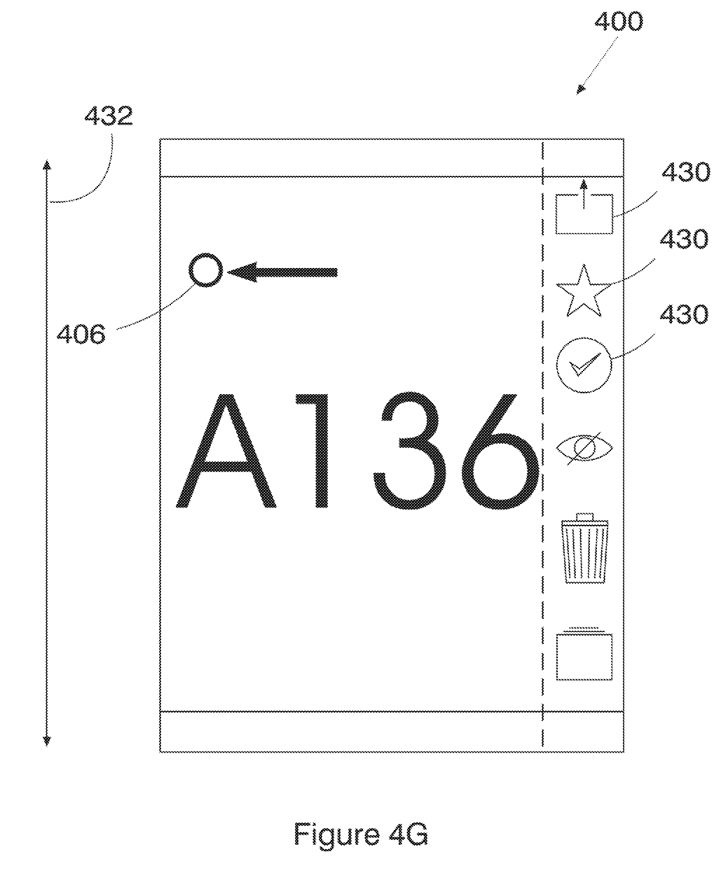

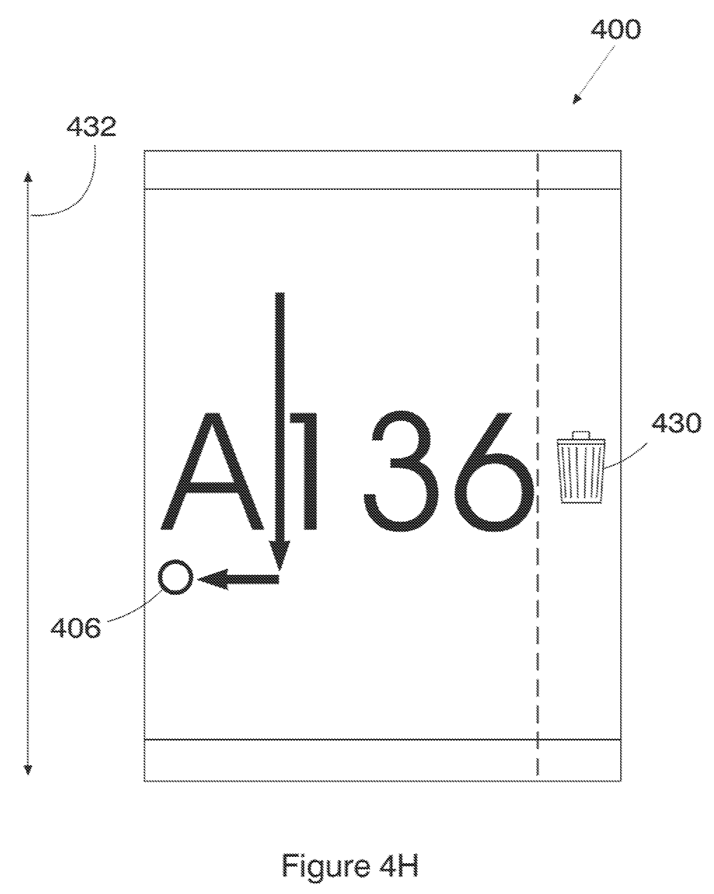

The display component (130) may be configured to display a subset of the rows on a display of the electronic device or to cause the rows to be displayed, for example, on the screen of a mobile phone or tablet computer. Some of the rows may be only partially displayed, as is shown in FIGS. 4A to 4H. The scrolling tracking component (140) may be configured to track scrolling user input. Scrolling user input may be carried out by way of pointer movement, particularly pointer movement along a scrolling axis. Similarly, the zooming tracking component (145) may be configured to track zooming user input, which may be carried out by way of pointer movement, particularly pointer movement along a zooming axis. In some embodiments, the electronic device provides a touch-sensitive input region and user input is detected when the user touches the input region with a finger or other pointing tool.

The scrolling component (150) may be configured to, in response to detecting user input along the scrolling axis, cause scrolling to be performed in relation to the set of items to enable the user to view rows not previously in the displayed subset. The zooming component (160) may include a zooming-out component (162) configured to, in response to detecting zooming-out user input proportionally to user input detected, progressively cause items to decrease in size and concurrently flow along the rows in the order in which the items are arranged, towards an anchor point. The zooming component (160) may further include a zooming-in component (164) configured to, in response to detecting zooming-in user input, proportionally to user input detected, progressively cause items to increase in size and concurrently flow along the rows in the order away from the anchor point.

As stated above, embodiments of the user interface (100) may include a marker component (170). The marker component (170) may be configured to display markers along with the subset of rows on the display of the electronic device which identify common features of groups of items in the set. In some embodiments, the selectable items may be images, videos or other media files, and the markers may be timeline markers identifying certain periods of time associated with the images or videos so that a user may identify selectable items corresponding to certain dates. It will be apparent to a person skilled in the art that many alternative markers may be used, for example file name, genre, artist, user rating, album name, to name but a few. The type of marker available may depend on the type of selectable item presently forming part of the list.

FIG. 2 shows a series of conceptual drawings (200) illustrating principles underlying embodiments of the described user interfaces. The conceptual drawings (200) are numbered from “2A” to “2E”.

The user interfaces provided herein may be termed “Spatial User Interfaces (SUIs)”. A goal of the SUI technique is to provide a substantially seamless transformation from a two-dimensional grid-based data set to a one-dimensional timeline set. To achieve such a transformation, a timeline (202), part of which is displayed on a display (204) of an electronic device is provided. When scrolling, the timeline moves up or down such that different parts thereof become visible on the display (204).

The concept is partially conceptualised by picturing an ordered set of selectable items (206) wrapped around the timeline (202) to form a helix with items capable of flowing along the helix in directions as indicated by the directional arrows in the drawings (200). This principle is illustrated in the drawing numbered 2A.

From this basis, the helix may be transformed by selecting an anchor point, indicated by an “X” in FIGS. 2D and 2E, and essentially cutting the helix such that the flow directions are in a first direction above the anchor point and in a second direction below the anchor point. These transformations are illustrated in FIGS. 2B to 2D.

Positioned in this way, selectable items become arranged either above or below the anchor point. Individual selectable items (208) are shown in FIG. 2E, which illustrates an exemplary display employing the principles described above. In order to effect zooming-in so as to enlarge the selectable items, items will flow in the directions indicated to gradually move away from the anchor point. As zooming-in occurs, items will appear to spill over one row and into a next, while some of the items will recede from the display and the remaining items will progressively enlarge to effect a continuous transformation. To zoom out, items will flow in the opposite direction to the directions indicated and will progressively reduce in size such that more items “fit” into the display and each row contains a larger number of items.

For example, when zooming-in occurs, the selectable item marked “Y” will progressively enlarge and eventually flow away from the anchor point and over to the row wherein the item “Z” is currently positioned, while item “Z” may flow so as to recede from the display if sufficient zooming-in occurs. Inversely, when zooming-out occurs, item “Z” will progressively become smaller and will flow towards the anchor point and the position of “Y”, while “Y” will also become smaller and may eventually flow so as to no longer be cut off, but to have its entirety contained in the row of the anchor point. In some cases, the anchor point remains substantially stationary while still becoming smaller or larger with the flowing items, while the other items flow either towards or away from it as described above.

In the drawing 2E of FIG. 2, the user interface displays items near the anchor point in a middle region of the display (204) as larger than items further away from the middle region. In other embodiments, and as will be described below, selectable items may be substantially equally sized.

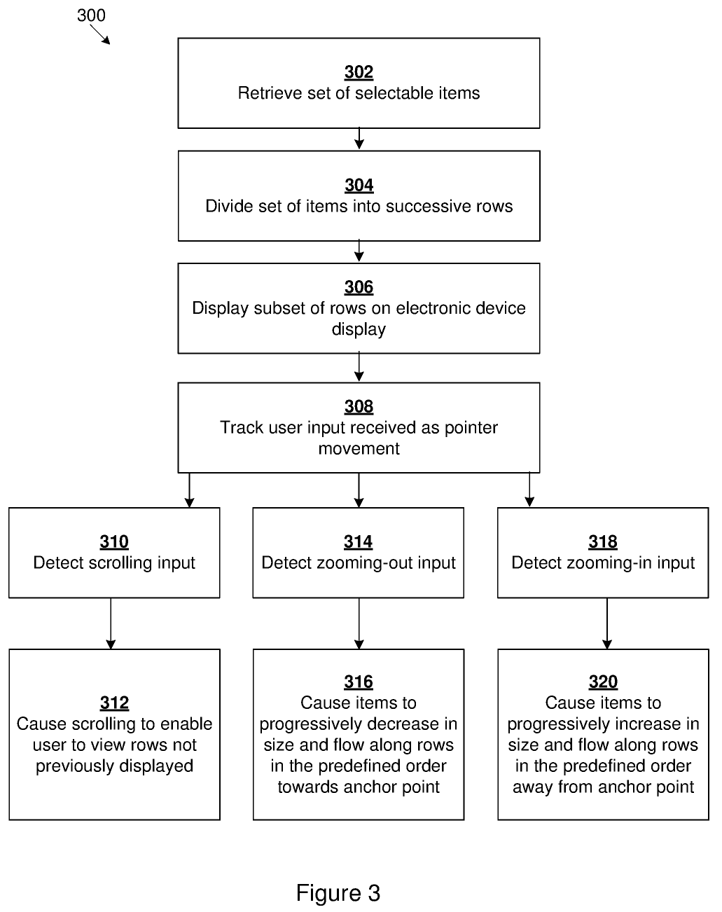

The flow diagram (300) of FIG. 3 illustrates steps performed in a method of enabling a user to navigate a set of selectable items in a user interface associated with an electronic device. The exemplary method described utilises the principles described with reference to the conceptual diagrams of FIG. 2. In the description of the steps of FIG. 3 reference is made to FIGS. 4A to 4H, which are exemplary screenshots of the display of an electronic device, illustrating some of the stages referred to in FIG. 3.

Turning to FIG. 3, at a first stage (302), a set of selectable items is retrieved. In this example, the electronic device providing the user interface is a tablet computer, the display (400) of the tablet computer being shown in FIGS. 4A to 4H to provide a visual illustration of the example described. The selectable items retrieved will typically depend on a selection made by the user. In this example, and primarily for illustrative purposes, the user has selected a “Photos” option, after which the user interface retrieves a set of photos arranged in an order and stored in a memory of the tablet computer.

At a next stage (304), the set of selectable items is divided into a plurality of successive rows. In this embodiment, individual items in each row are positioned according to the order such that the last item in row Y is an item X and the first item in row Y+1 is item X+1. For example, the last item in the first displayed row is photo “A105” and the first item in the succeeding row is photo “A106”. At a next stage (306), a subset of the rows are displayed on the display (400) of the electronic device. At this stage, the rows each include six selectable items which are of equal size.

This stage (306) is shown in FIG. 4A. FIG. 4A illustrates the subset of selectable items (402) displayed in rows (404), the user capable of interacting with the items (402) by moving a pointer (406). The pointer (406) is shown as a dot in FIGS. 4A to 4H primarily for exemplary purposes, and it should be noted that the term “pointer” may simply refer to the position of the user's finger or other pointer tool as detected by the user interface. The pointer will therefore in some cases not be displayed. The photos of this example are marked (e.g. “A100”, “A101”) to indicate the order in which they are arranged along the various rows.

The rows (404) of items are, in this example, arranged successively along a scrolling axis (408) and extend substantially transversely to the scrolling axis (408) and parallel to a zooming axis (410). The zooming axis (410) is thus, in this embodiment, substantially transverse to the scrolling axis (408). It should, however, be understood that these axes may lie in other orientations in relation to each other and need not be transversely disposed. Pointer movement along the scrolling axis (408) and the zooming axis (410), in either a zooming-in (412) or zooming-out (414) direction thereof, allows the user to change the manner in which items are displayed, as will be described below.

The user interface of this example is also configured to display markers (416) in a marker zone (418) along with the subset of rows on the display (400). In this and other embodiments, the markers (416) identify common features of groups of items in the set. In this particular case, the markers (416) are arranged along the scrolling axis (408) and the marker zone (418) overlays a portion of the displayed selectable items, the markers (416) serving as timeline markers which identify certain periods of time associated with the displayed photos. For example, photo “A120” is associated with September 2014 while photo “A135” is associated with October 2014.

In some embodiments, the order is determined at least partially by the markers. For example, if the markers are dates and times, the items may be arranged chronologically. If the markers are location tags, the items may be arranged according to the location with which they are associated.

The order may be selectable by a user, and may include sorting the selectable items by file properties. Additionally, a user may be allowed to delete, add, duplicate or shuffle or swop selectable items, which will change the order.

At a next stage (308), user input carried out by way of pointer movement is tracked. The manner in which the rows (404) and selectable items (402) are adjusted and updated in response to such user input depends on whether the user interface detects scrolling input, zooming-out input or zooming-in input.

The user may, at a following stage (310), move the pointer along the scrolling axis (408). The user interface detects user input along the scrolling axis (408). In this example, the user moves his finger upwards as shown by the directional arrow in FIG. 4B. In response to detecting user input along the scrolling axis (408), the user interface at a next stage (312) causes scrolling to be performed in relation to the set of items proportionally to the input received. This enables the user to view rows not previously in the displayed subset without substantially adjusting the size and number of items per row. In this example, a number of rows (420) which were not visible in FIG. 4A become visible as the rows gradually shift upwards in accordance with the input received, while other rows recede from the display to make room for the newly displayed rows (420). In FIG. 4A, photos “A100” to “A141” are visible, the row containing “A141” being partially cut off, while in FIG. 4B, photos “A124” to “A159” are visible, with a row above the row containing “A124” being partially in the display (400).

Use of the scrolling axis (408) may thus provide the user with a timeline view capability, particularly in cases where the markers (416) provide information as to the date and/or time associated with the selectable items. The scrolling action described above has made photos corresponding to the “November” and “December” markers visible, and has caused the “August” marker and its associated photos to move upward and recede from the display (400). In this embodiment, scrolling does not cause the size of items or the number of items per row to change.

The user may wish to zoom out to obtain a view of a larger number of selectable items, without having to, for example, perform a discrete “click” by selecting a “Back” option. The user may, at a next stage (314), move the pointer (406) in the zooming-out direction (414) along the zooming axis (410). This pointer movement is shown by the directional arrow in FIG. 4C.

In response to detecting user input in the zooming-out direction (414) along the zooming axis (410), proportionally to pointer movement detected, the user interface at a next stage (316) causes selectable items (402) to progressively decrease in size and concurrently flow along the rows in the predefined order towards an anchor point (422) as the pointer (406) moves. Reducing the size of the selectable items (402) may also reduce their resolution. In this embodiment, the anchor point (422) is one of the selectable items (photo “A136”). The anchor point (422) may remain substantially stationary on the display (400) while other selectable items flow towards it.

It should be noted that the anchor point may be associated with a predefined position on the display of the electronic device, a predefined item position and/or a predefined row position, and need not be associated with a specific item as is the case in FIGS. 4A to 4H. Alternatively, the anchor point may be determined or may be adjusted depending on user input. For example, the anchor point may move to allow further or faster scrolling, or may be positioned based on pointer position. Such movement may be in the direction of a scrolling axis.

In some embodiments, and as shown in FIG. 4C, items in rows preceding the anchor point (422) flow towards the anchor point in a first direction (426) (indicated by broken line arrows) and items in rows succeeding the anchor point flow towards the anchor point in a second direction (428) (also indicated by broken line arrows). In this way, the rows are dynamically rearranged such that the number of items per row progressively increases and at least some items not previously in the displayed subset of selectable items flow into the display (400). It should also be noted that, at certain stages and/or while items are flowing between rows, some items may be cut off so as to be displayed partially at the end of the row and partially at the beginning of a succeeding row. This “cutting off” is illustrated in FIGS. 4C to 4F. For example, photo “A136” is cut off in FIG. 4C, but moves so as to become completely displayed in one row in FIG. 4D.

At this stage (316), a greater number of selectable items (402) are contained in each row and the item size of each item has been reduced. FIG. 4C shows that photos “A99” to “A191” are now substantially visible in the display (400). The user may wish to zoom out even further, and moves the pointer (406) further in the zooming-out direction (414) of the zooming axis (400). As a result, even more items flow into the display and become visible, as shown in FIG. 4D. The anchor point (424) remains substantially fixed, with items above it flowing towards the anchor point (424) in the direction (426) shown and with items below it flowing towards the anchor point (424) in the opposite direction (428), as shown in FIG. 4D.

As the user scrolls or zooms, and as the rows are dynamically rearranged, the markers (416) are also typically dynamically rearranged. For example, in FIG. 4D, as zooming-out is performed, more photos flow into the display, and the months (“July”, “January”, etc.) associated with the newly displayed photos become identified by newly displayed markers. In FIG. 4D it is shown that photos “A87” to “A194” are visible. The “cutting-off” indicates to a user that an item will move to a next row or will move into the current row, depending on whether zooming in or zooming out is taking place. This provides the technical effect of informing the user that there are more items to come on the next row or that items are approaching from the next row.

The above technique allows the user to obtain an overarching view of items available for selection so as to facilitate reaching the desired item more rapidly. In some embodiments, the user may at this stage click on or otherwise select a desired item. The user interface may then cause zooming in to occur such that the desired item is enlarged and/or selected for further interaction. Otherwise, the user may also perform scrolling to bring a desired item into view.

Referring back to FIG. 4B, instead of zooming out, the user may wish to zoom in to obtain a view of a smaller number of items or a specific item. The user may thus, at a next stage (318), move the pointer (406) in the zooming-in direction (412) along the zooming axis (410). This pointer movement is shown by the directional arrow in FIG. 4E.

At a next stage (320), in response to detecting user input in the zooming-in direction (412) along the zooming axis (410), the user interface, proportionally to pointer movement detected, causes items to progressively increase in size and concurrently flow along the rows in the predefined order away from the anchor point (424), which is also photo “A136” in this case, so as to dynamically rearrange each row while the pointer is moving such that the number of items per row progressively decreases and at least some items recede from the display.

Inversely to the zooming-out process, during zooming-in, items in rows preceding the anchor point (424) flow away from the anchor point in the second direction (428) and items in rows succeeding the anchor point flow away from the anchor point in the first direction (426). In this way, fewer items are visible (only photos “A133” to “A141” are now completely in view) and the items that are visible are substantially larger in FIG. 4E than at the stage shown in FIG. 4B. As the selectable items increase in size, their resolution may also be increased.

The user may wish to zoom in even further so as to interact only with photo “A136”. The user moves the pointer (406) further in the zooming-in direction (412) along the zooming axis (410). As the pointer (406) is moved, items further increase in size and concurrently flow along the rows in the predefined order away from the anchor point to the extent that only photo “A136” is fully visible. This stage is shown in FIG. 4F. Once the pointer (406) moves to this point in the zooming-in direction, the markers may disappear or gradually move out of the display (400).

Once the pointer (406) is moved past a certain threshold, only photo “A136” is visible and the user interface displays a number of interactive options (430) on the display (400) which are associated with the selectable item. Examples of these options (430) are shown in FIG. 4G, and they may include options such as “Share”, “Favourite”, “Select”, “Make invisible”, Delete” and/or “Move to folder”. Instead of providing a scrolling axis at this stage, the longitudinal axis becomes an interactive option axis (432). Movement of the pointer (406) up and down along the interactive option axis (432) does not cause scrolling but will cause a different interactive option (430) to become selectable. It should be noted that the resolution of the only photo currently in the display may be at a maximum when so displayed.

FIG. 4H shows how the user moves the pointer (406) downward such that the “Delete” interactive option (430) becomes selectable and then in the zooming-in direction such that the other interactive options (430) recede from the display (400). To delete the photo, the user may move the pointer (406) further in the zooming-in direction along the zooming axis. To return to the other interactive options (430), the user may move the pointer back in the zooming-out direction.

It should be understood that the user may at any time after zooming in choose to zoom out as described with reference to FIGS. 4C and 4D instead of zooming in to and interacting with a particular selectable item.

It is envisaged that in some embodiments, upon detecting that the user input includes components of pointer movement along both the scrolling axis and the zooming-out direction of the zooming axis, the user interface may be configured to cause scrolling and zooming-out to be substantially simultaneously performed. For example, if the pointer is moved diagonally across the display, the user interface may detect two components of movement and cause scrolling and zooming to occur.

Similarly, upon detecting that the user input includes components of pointer movement along both the scrolling axis and the zooming-in direction of the zooming axis, the user interface may be configured to cause scrolling and zooming-in to be substantially simultaneously performed.

Further, in some embodiments the user interface may provide a zooming direction reversal option. The user may select this option to cause the zooming-in direction to become the zooming-out direction and the zooming-out direction to become the zooming-in direction.

In some embodiments, the rows of selectable items described above may form a first z-axis layer, and the markers may be provided in a second and/or subsequent z-axis layers that are partially visible so as to be arranged between some of the items in the rows. In such cases, scrolling or dynamic rearrangement of rows may cause different portions of the second and/or subsequent layers to become visible.

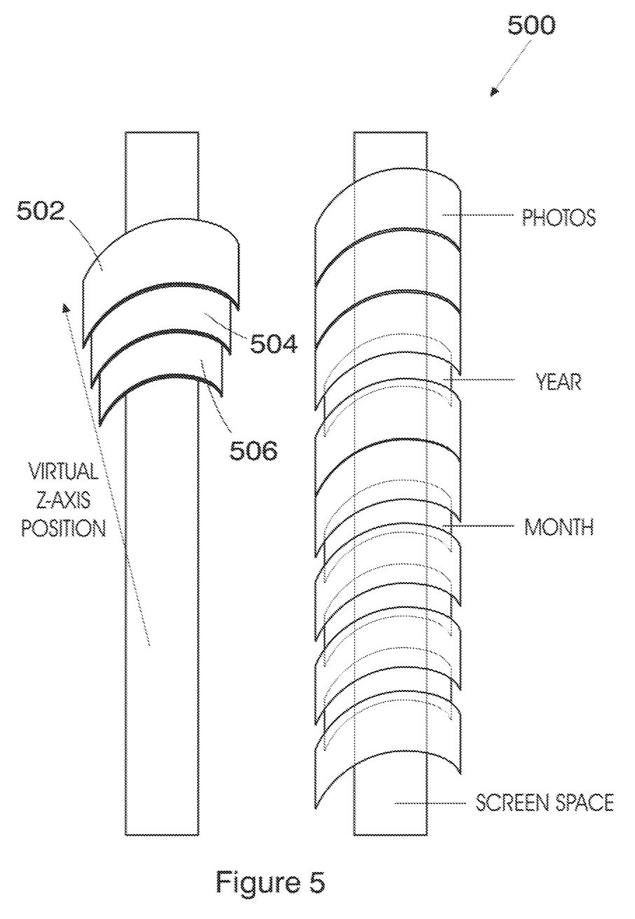

FIG. 5 is a conceptual drawing (500) illustrating principles underlying z-axis layers which may be provided by embodiments of a user interface. In this drawing, and primarily to illustrate the principle of z-axis layers, the markers “year” (504) and “month” (506) are provided as a second and third z-axis layer which are associated with photos (502) that form the first z-axis layer. The markers may of course be associated with any feature of a selectable item or items, not necessarily time or date. For example, the markers may be event tags, location tags or people tags.

Whereas the markers were displayed as a timeline visualisation overlaying the selectable items in FIGS. 4A to 4H, “z-axis layer” embodiments provide an integrated technique for displaying selectable items and their markers. Different virtual z-axis positions are allocated to each category of helix band (as described with reference to FIG. 2), and bands are capable of essentially opening up to reveal information from lower z-axis levels.

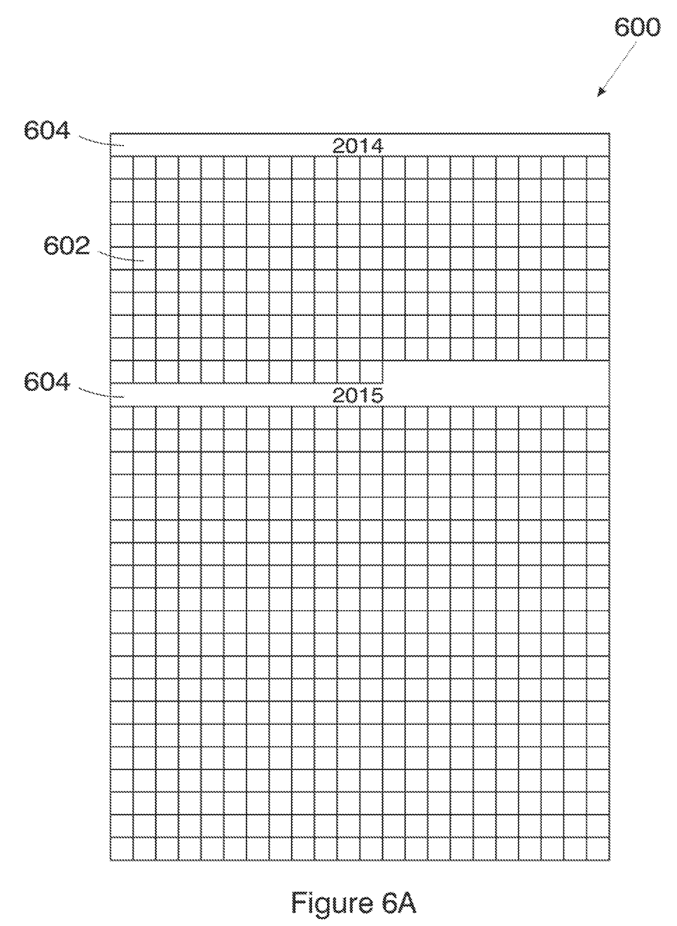

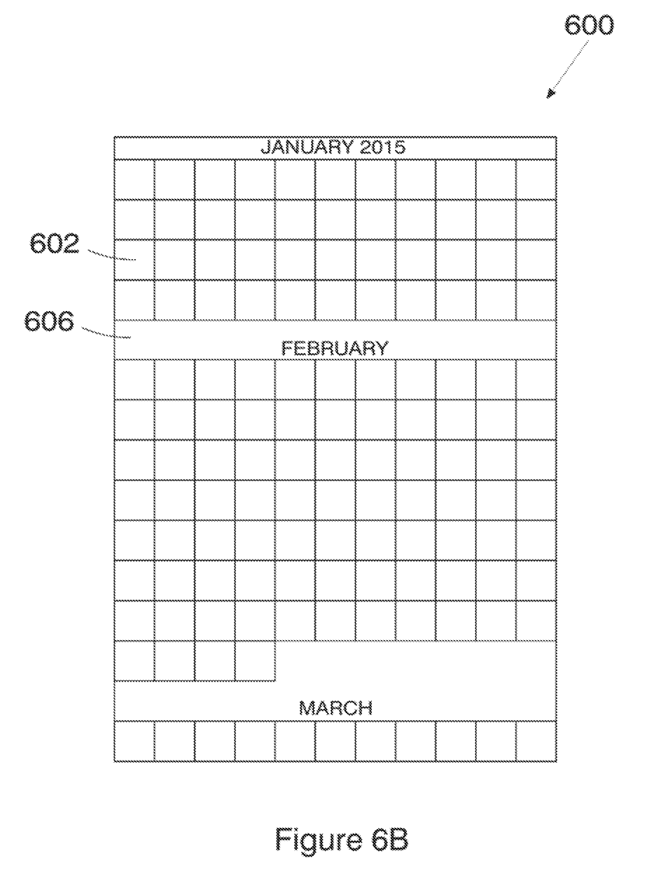

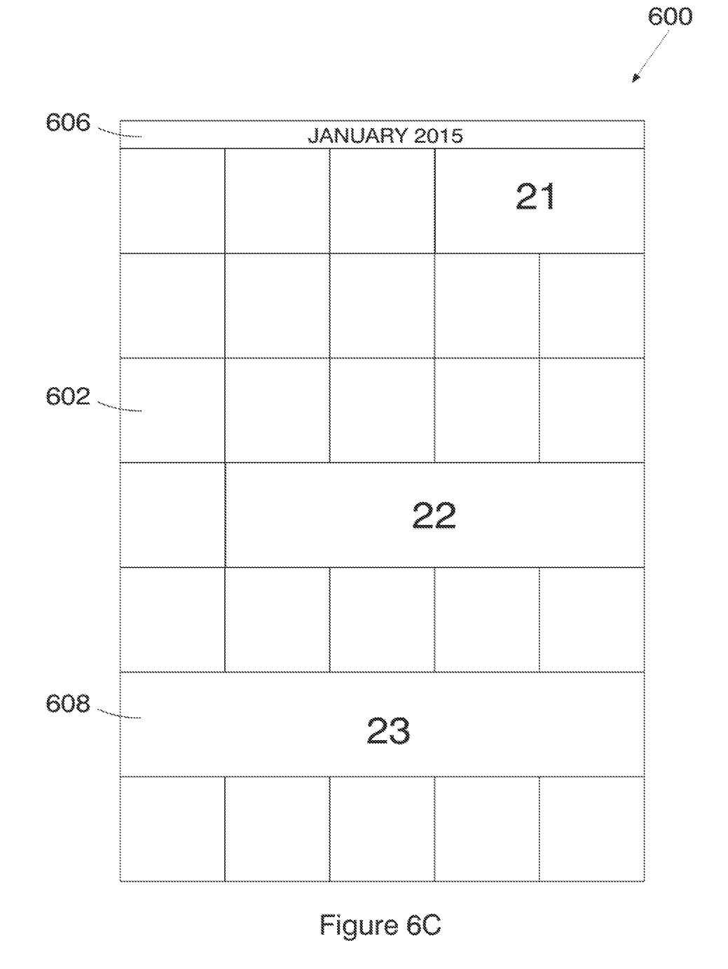

FIGS. 6A-6C are exemplary screenshots of the display of an electronic device, illustrating different stages in a method of enabling a user to navigate a set of selectable items in a user interface of the electronic device, wherein the user interface provides multiple z-axis layers. In this example, the markers are displayed so as to be arranged between some of the selectable items in the rows. The layers provide a navigable tree structure, rather than a list structure.

A first stage is shown in FIG. 6A. In this figure, a zoomed-out state is shown wherein only a first z-axis layer (602), namely the selectable items themselves, and a second z-axis layer (604), the marker “year”, is shown on the display (600) of the electronic device.

If the user moves the pointer so as to zoom in, the rows may open up to reveal a further z-axis layer. In FIG. 6B, a third z-axis layer (606), the marker “month”, is revealed as the user zooms in, while in FIG. 6C, a fourth z-axis layer (608), the marker “day” is revealed. The user may in this way be provided with increasingly specific information relating to the selectable items shown as zooming in occurs.

A multitude of layers may be exposed as described in FIGS. 6A to 6C, possibly up to ten or more. The user interface may be configured to introduce spacing between currently shown rows at specific levels of zoom. When further spacing is introduced, the additional layer at teat spacing may gradually appear. This may have the appearance of items spawning in the space provided.

This layering may allow a user to gradually zoom into and locate a desired selectable item, thereby allowing navigation of a large number of selectable items at a quicker speed than if the user were simply to scroll through a list.

Embodiments of the methods and user interfaces provide a technical tool for efficient display and navigation of items in a user interface. The technical features relate to the format of the items displayed. The functions of processing the items in a specific format, i.e. varying the number of items in row and at a size and/or level of resolution, provides information to the user in the form of a technical tool for a navigation task.

The display and navigation formatting enable as user to obtain an overarching view of selectable items without being required to provide a number of separate, discrete inputs. Selectable items are more efficiently located and/or viewed.

A technique and user interface is provided which may enable a user to more easily and fluently navigate a set of selectable items, in some cases without the need to provide a number of discrete inputs so as to make the desired item visible and/or sufficiently clear on the display of the electronic device. As a result, a number of so-called “point and click” actions may no longer be required and navigation speed may be enhanced. The combination of the user inputs with the evolving display and resolution of the items, enables a technical effect of efficient navigation.

The above description is by way of example only and it should be appreciated that numerous changes and modifications may be made to the embodiments described without departing from the scope of the invention.

Control-display functions such as lens functions may be employed in some embodiments such that some items and/or rows may be greater in size and/or focus in relation to other items and/or rows. In some embodiments, the functions employed to dynamically update rows and items as the pointer is moved may include a zooming function, a scaling function and/or a lens function. The lens function causes the region corresponding to the pointer position to be enlarged in relation to other interactive items. The lens function may provide a distorted view of the items in an attempt to show the context created by the movement of the user.

In some embodiments, the scrolling axis may be defined as a longitudinal axis associated with the display, and the zooming axis may be defined as a short axis associated with the display, while in other embodiments the scrolling axis may be defined as the short axis, with the zooming axis being the longitudinal axis.

The electronic device may include a processor for executing the functions of components described below, which may be provided by hardware or by software units executing on the electronic device. The software units may be stored in a memory component and instructions may be provided to the processor to carry out the functionality of the described components.

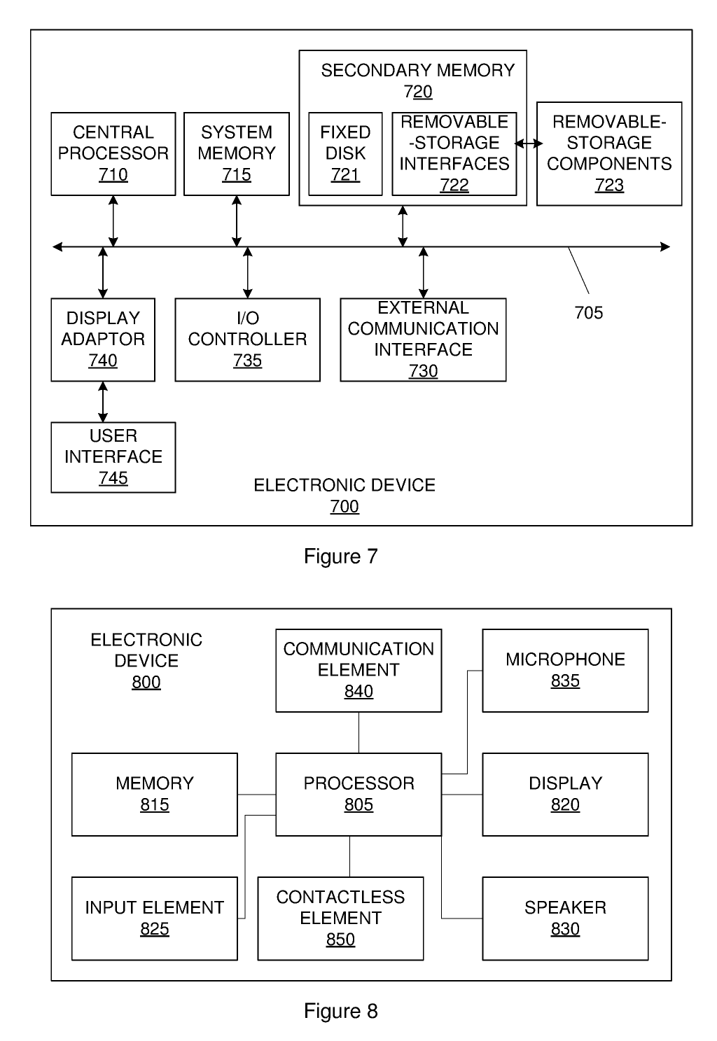

FIG. 7 illustrates an example of an electronic device (700) in the form of a computing system in which various aspects of the disclosure may be implemented. The electronic device (700) may be suitable for storing and executing computer program code. The various participants and elements in the previously described system diagrams, for example mobile phones, tablet computers, personal computers, laptops, televisions and domestic appliances, may use any suitable number of subsystems or components of the electronic device (700) to facilitate the functions described herein. The electronic device (700) may include subsystems or components interconnected via a communication infrastructure (705) (for example, a communications bus, a cross-over bar device, or a network). The electronic device (700) may include one or more central processors (710) and at least one memory component in the form of computer-readable media. In some configurations, a number of processors may be provided and may be arranged to carry out calculations simultaneously. In some implementations, a number of electronic devices (700) may be provided in a distributed, cluster or cloud-based computing configuration and may provide software units arranged to manage and/or process data on behalf of remote devices.

The memory components may include system memory (715), which may include read only memory (ROM) and random access memory (RAM). A basic input/output system (BIOS) may be stored in ROM. System software may be stored in the system memory (715) including operating system software. The memory components may also include secondary memory (720). The secondary memory (720) may include a fixed disk (721), such as a hard disk drive, and, optionally, one or more removable-storage interfaces (722) for removable-storage components (723). The removable-storage interfaces (722) may be in the form of removable-storage drives (for example, magnetic tape drives, optical disk drives, etc.) for corresponding removable storage-components (for example, a magnetic tape, an optical disk, etc.), which may be written to and read by the removable-storage drive. The removable-storage interfaces (722) may also be in the form of ports or sockets for interfacing with other forms of removable-storage components (723) such as a flash memory drive, external hard drive, or removable memory chip, etc.

The electronic device (700) may include an external communications interface (730) for operation of the electronic device (700) in a networked environment enabling transfer of data between multiple electronic devices (700). Data transferred via the external communications interface (730) may be in the form of signals, which may be electronic, electromagnetic, optical, radio, or other types of signal. The external communications interface (730) may enable communication of data between the electronic device (700) and other electronic devices including servers and external storage facilities. Web services may be accessible by the electronic device (700) via the communications interface (730). The external communications interface (730) may also enable other forms of communication to and from the electronic device (700) including, voice communication, near field communication, radio frequency communications, such as Bluetooth™, etc.

The computer-readable media in the form of the various memory components may provide storage of computer-executable instructions, data structures, program modules, software units and other data. A computer program product may be provided by a computer-readable medium having stored computer-readable program code executable by the central processor (710). A computer program product may be provided by a non-transient computer-readable medium, or may be provided via a signal or other transient means via the communications interface (730).

Interconnection via the communication infrastructure (705) allows the central processor (710) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, and the like) may couple to the electronic device (700) either directly or via an I/O controller (735). These components may be connected to the electronic device (700) by any number of means known in the art, such as a serial port. A user interface (745) as described herein may be coupled via a display or video adapter (740) to the electronic device (700).

FIG. 8 shows another embodiment of a block diagram of an electronic device (800) in the form of a communication component. The various participants and elements in the previously described system diagrams, for example mobile phones, tablet computers, personal computers and laptops, may use any suitable number of subsystems or components of the electronic device (800). The electronic device (800) may be a cell phone, a feature phone, a smart phone, a satellite phone, or a computing device having a phone capability.

The electronic device (800) may include a processor (805) (e.g., a microprocessor) for processing the functions of the electronic device (800) and a display (820) to allow a user to see the phone numbers and other information and messages which may include a user interface as described herein. The electronic device (800) may further include an input element (825) to allow a user to input information into the device (e.g., input buttons, touch screen, etc.), a speaker (830) to allow the user to hear voice communication, music, etc., and a microphone (835) to allow the user to transmit his or her voice through the electronic device (800). The processor (810) of the electronic device (800) may connect to a memory (815). The memory (815) may be in the form of a computer-readable medium that stores data and, optionally, computer-executable instructions.

The electronic device (800) may also include a communication element (840) for connection to communication channels (e.g., a cellular telephone network, data transmission network, Wi-Fi™ network, satellite-phone network, Internet network, Satellite Internet Network, etc.). The communication element (840) may include an associated wireless transfer element, such as an antenna. The communication element (840) may include a subscriber identity module (SIM) in the form of an integrated circuit that stores an international mobile subscriber identity and the related key used to identify and authenticate a subscriber using the electronic device (800). One or more subscriber identity modules may be removable from the electronic device (800) or embedded in the electronic device (800).

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. In one embodiment, a software unit is implemented with a computer program product comprising a non-transient computer-readable medium containing computer program code, which can be executed by a processor for performing any or all of the steps, operations, or processes described. Software units or functions described in this application may be implemented as computer program code using any suitable computer language such as, for example, Java™′ C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A method of navigation of a set of items in a user interface associated with an electronic device, the method comprising the steps of:
retrieving a set of items;
dividing the set of items into a plurality of rows;
displaying a subset of the rows on a display of the electronic device;
tracking scrolling user input activating scrolling through the display;
tracking zooming user input activating zooming in or out of the display;
in response to detecting scrolling user input, causing scrolling to be performed in relation to the set of items to enable the user to view rows not previously in the displayed subset without substantially adjusting size and a number of items per row;
in response to detecting zooming user input in a zooming-out direction, proportionally to user input detected, progressively causing items to decrease in size and concurrently flow along the rows in a predefined order towards an anchor point so as to dynamically rearrange each row such that the number of items per row progressively increases and at least some items not previously in the displayed subset flow into the display; and
in response to detecting zooming user input in a zooming-in direction, proportionally to user input detected, progressively causing items to increase in size and concurrently flow along the rows in the predefined order away from the anchor point, so as to dynamically rearrange each row such that the number of items per row progressively decreases and at least some items recede from the display.

2. The method as claimed in claim 1, wherein the step of tracking scrolling user input includes user input in the form of pointer movement along a scrolling axis, and the step of tracking zooming user input includes user input in the form of pointer movement along a substantially transverse zooming axis.

3. The method as claimed in claim 1, wherein individual items in each row are positioned according to the predefined order such that a last item in a row Y is an item X and a first item in a row Y+1 is an item X+1, and wherein the rows extend substantially vertically to the scrolling axis.

4. The method as claimed in claim 3, wherein at least one last item in a row is cut off so as to be displayed partially at an end of the row and partially at a beginning of a succeeding row thereby informing a user that there are more items to come on a next row.

5. The method as claimed in claim 1, wherein the step of causing items to decrease in size and concurrently flow along the rows in the predefined order towards the anchor point includes items in rows preceding the anchor point flowing towards the anchor point in a first direction and items in rows succeeding the anchor point flowing towards the anchor point in a second direction, and wherein the step of causing items to increase in size and concurrently flow along the rows in the predefined order away from the anchor point includes items in rows preceding the anchor point flowing away from the anchor point in the second direction and items in rows succeeding the anchor point flowing away from the anchor point in the first direction.

6. The method as claimed in claim 1, including: upon detecting both scrolling user input and zooming user input, causing scrolling and zooming-in or zooming-out to be substantially simultaneously performed.

7. The method as claimed in claim 1, including displaying markers along with the subset of rows on the display of the electronic device, the markers identifying common features of groups of items in the set.

8. The method as claimed in claim 1, wherein the rows of items form a first z-axis layer, the markers are provided in a second and/or subsequent z-axis layer that are partially visible so as to be arranged between some of the items in the rows, and scrolling or dynamic rearrangement of rows cause different portions of the second and/or subsequent layers to become visible.

9. The method as claimed in claim 1, wherein the items are images or videos, and the markers are timeline markers identifying certain periods of time associated with the markers.

10. The method as claimed in claim 2, wherein the scrolling axis is defined as a longitudinal axis associated with the display and the zooming axis is defined as a short axis associated with the display, alternatively wherein the scrolling axis is defined as a short axis associated with the display and the zooming axis is defined as a longitudinal axis associated with the display, and wherein the user interface is configured to provide a zooming direction reversal option such that the zooming direction becomes the zooming-out direction and the zooming-out direction becomes the zooming-in direction.

11. A user interface configured to enable navigation of a set of items wherein the user interface is associated with an electronic device, the user interface comprising:
an item retrieving component configured to retrieve a set of items;
a row allocation component configured to divide the set of items into a plurality of rows;
a display component configured to display a subset of the rows on a display of the electronic device;
a scrolling tracking component configured to track scrolling user input;
a zooming tracking component configured to track zooming user input zooming in or out of the display;
a scrolling component configured to, in response to detecting scrolling user input, cause scrolling to be performed in relation to the set of items to enable the user to view rows not previously in the displayed subset without substantially adjusting a size and number of items per row; and
a zooming component configured to:
in response to detecting user zooming user input in a zooming-out direction, proportionally to user input detected, progressively cause items to decrease in size and concurrently flow along the rows in a predefined order towards an anchor point so as to dynamically rearrange each row such that the number of items per row progressively increases and at least some items not previously in the displayed subset flow into the display; and
in response to detecting zooming user input in a zooming-in, proportionally to user input detected, progressively cause items to increase in size and concurrently flow along the rows in the predefined order away from the anchor point, so as to dynamically rearrange each row such that the number of items per row progressively decreases and at least some items recede from the display.

12. The user interface as claimed in claim 11 wherein the zooming component is further configured to, while causing items to decrease in size and concurrently flow along the rows in the predefined order towards the anchor point, cause items in rows preceding the anchor point to flow towards the anchor point in a first direction and items in rows succeeding the anchor point to flow towards the anchor point in a second direction, and is configured to, while causing items to increase in size and concurrently flow along the rows in the order away from the anchor point, cause items in rows preceding the anchor point to flow away from the anchor point in the second direction and items in rows succeeding the anchor point to flow away from the anchor point in the first direction.

13. The user interface as claimed in claim 11 which is configured to, upon detecting both scrolling user input and zooming user input, cause scrolling and zooming-in or zooming-out to be substantially simultaneously performed.

14. The user interface as claimed in claim 11 which includes a marker component configured to display markers along with the subset of rows on the display of the electronic device, the markers identifying common features of groups of items in the set of items.

15. A computer program product for navigation of a set of items in a user interface associated with an electronic device, the computer program product comprising a non-transitory computer-readable medium having stored computer-readable program code, the computer-readable program code executable by a processing circuit to perform the steps of:
retrieving a set of items;
dividing the set of items into a plurality of rows;
displaying a subset of the rows on a display of the electronic device;
tracking scrolling user input activating scrolling through the display;
tracking zooming user input activating zooming in or out of the display;
in response to detecting scrolling user input, causing scrolling to be performed in relation to the set of items to enable the user to view rows not previously in the displayed subset without substantially adjusting a size and a number of items per row;
in response to detecting zooming user input in a zooming-out direction, proportionally to user input detected, progressively causing items to decrease in size and concurrently flow along the rows in a predefined order towards an anchor point so as to dynamically rearrange each row such that the number of items per row progressively increases and at least some items not previously in the displayed subset flow into the display; and
in response to detecting zooming user input in a zooming-in direction, proportionally to user input detected, progressively causing items to increase in size and concurrently flow along the rows in the predefined order away from the anchor point, so as to dynamically rearrange each row such that the number of items per row progressively decreases and at least some items recede from the display.
